(19) United States
(12) Patent Application Publication
(10) Pub. No.: US 2026/0346181 A1
(43) Pub. Date: Nov. 5, 2026

(54) ROTATING PACKED BEDS COMPRISING WIRE-BASED PACKING MATERIAL

(71) Applicants: Research Triangle Institute, Research Triangle Park, NC (US); SLB Capturi USA LLC, Sugar Land, TX (US)

(72) Inventors: Paul Mobley, Raleigh, NC (US); Katy Jessop, Cary, NC (US); Lucas Cody, Cary, NC (US); Colin Tart, Garner, NC (US); Sara Escanero Ereza, Sugar Land, TX (US); Alexander Slocum, Bow, NH (US); Marycruz Romand Sanchez, Sugar Land, TX (US); Yiyan Chen, Sugar Land, TX (US)

(21) Appl. No.: 19/650,063

(22) Filed: Apr. 16, 2026

Related U.S. Application Data
(60) Provisional application No. 63/790,622, filed on Apr. 17, 2025.

(51) Int. Cl. B01D 53/02; B01D 53/40; B01D 53/78

(52) U.S. Cl. CPC B01D 53/025; B01D 53/40; B01D 53/78

(57) ABSTRACT

The disclosure provides an apparatus, as well as associated systems and methods suitable, e.g., for removing components (e.g., acid gases) from gas streams. The disclosure specifically provides a rotating packed bed (RPB)-based apparatus with a wire-based packing material designed to provide increased surface area for liquid-gas contact, which can be employed within a range of carbon capture and sequestration (CCS) systems. Various advantages, e.g., with respect to spatial considerations and associated expenses can be realized using the apparatus, systems, and methods described herein.

### CROSS-REFERENCE TO RELATED APPLICATIONS

The present application claims priority to U.S. Provisional Patent Application No. 63/790,622, filed Apr. 17, 2025, the disclosure of which is incorporated herein by reference in its entirety.

### FIELD OF THE DISCLOSURE

The present invention relates to components and systems for the removal of specific compounds that may be present within gas streams (e.g., acid gases, such as CO₂, SO₂, COS, H₂S, CS₂ and NOₓ), as well as to methods of using such components and systems. The disclosed components and systems can also be employed for the catalysis of certain reactions.

### BACKGROUND

Combustion of fossil fuels such as coal, oil, and natural gas is expected to remain the major global energy source for years to come. Currently, 65% of the world's greenhouse gas emissions stem from fossil fuel-fired power plants, whose usage is anticipated to increase by as much as 28% by 2040 from vast growth in emerging markets including China and India. The environmental impact of anthropogenic carbon dioxide (CO₂) emissions has prompted a world-wide effort to reduce CO₂ atmospheric release. Carbon capture and sequestration (CCS) technologies have advanced over the last decade to become one of the most promising solutions to reduce CO₂ (and other acid gas) emissions.

In the context of CCS systems, much effort has been expended in developing new absorber technologies to maximize CO₂ capture (e.g., new sorbents and new processes) and it has been recognized that rotating packed beds (RPBs) can enhance CO₂ capture. See, e.g., U.S. Pat. Nos. 11,612,854 and 11,691,105, which are incorporated herein by reference in their entireties. However, relatively little has been done to develop new RPB-specific features. With increasing regulations on CO₂ emissions and the desire to decrease the costs of CO₂ removal via CCS technologies, it would be advantageous to provide additional features and modifications to RPBs e.g., for use within systems for treatment of CO₂-containing gases to further reduce the overall footprint and economics of the CCS system.

### BRIEF SUMMARY

The present disclosure provides an apparatus and associated system for the removal of gases, such as CO₂, from a gas stream and methods for removing gases using such an apparatus or system. In one aspect of the disclosure is provided a rotating packed bed (“RPB”) arranged on a rotatable shaft, the RPB comprising: a gas inlet through which an influent gas can enter for gas-liquid contact; a gas outlet through which an effluent gas can exit following the gas-liquid contact; a liquid inlet through which a liquid can enter for the gas-liquid contact; a liquid outlet through which the liquid can exit following the gas-liquid contact; and a conduit between the liquid inlet and the liquid outlet, the conduit comprising a liquid for the gas-liquid contact contained therein. The disclosed RPB uniquely comprises a wire-based packing material. In some embodiments, the wire-based packing material can increase effective mass transfer area and/or reduce the overall weight of the RPB as compared with conventional RPBs (e.g., comprising other types of packing material). In some embodiments, the wire-based packing material can be defined based on its void fraction and cavity size, as will be described further herein below. Non-limiting embodiments of the wire-based packing material described herein may exclude solid foams; that is, the wire-based packing material may be neither a closed-cell foam nor an open-cell foam. In some embodiments, the disclosed apparatus and system can optionally be configured so as to promote/catalyze one or more chemical reactions within the RPB, as will be described in further detail herein below.

The disclosure also provides a method of reducing capital and operating expenses associated with a system designed for capture of acid gas components from a gas stream, comprising employing an RPB with a packing material as described herein within the system in place of a conventional absorber and/or a conventional RPB (e.g., comprising a conventional packing material).

The present disclosure includes, without limitation, the following embodiments.

Embodiment 1: An apparatus, comprising a rotating packed bed (RPB) arranged on a rotatable shaft, the RPB comprising: a gas inlet through which an influent gas can enter for gas-liquid contact; a gas outlet through which an effluent gas can exit following the gas-liquid contact; a liquid inlet through which a liquid can enter for the gas-liquid contact; a liquid outlet through which the liquid can exit following the gas-liquid contact; and a conduit between the liquid inlet and the liquid outlet, the conduit comprising a liquid solvent for the gas-liquid contact contained therein, and a packing material within the conduit, wherein the packing material comprises a wire-based packing material, and wherein the wire-based packing material has a void fraction of greater than 0.8 and a cavity size of less than 1 mm.

Embodiment 2: The apparatus of Embodiment 1, wherein the wire-based packing material is a woven, knit, or nonwoven material.

Embodiment 3: An apparatus, comprising a rotating packed bed (RPB) arranged on a rotatable shaft, the RPB comprising: a gas inlet through which an influent gas can enter for gas-liquid contact; a gas outlet through which an effluent gas can exit following the gas-liquid contact; a liquid inlet through which a liquid can enter for the gas-liquid contact; a liquid outlet through which the liquid can exit following the gas-liquid contact; and a conduit between the liquid inlet and the liquid outlet, the conduit comprising a liquid solvent for the gas-liquid contact contained therein, and a packing material within the conduit, wherein the packing material comprises a wire-based packing material in the form of a mechanically entangled, nonwoven material.

Embodiment 4: The apparatus of Embodiment 3, wherein the wire-based packing material has a void fraction of greater than 0.8 and a cavity size of less than 1 mm.

Embodiment 5: The apparatus of any of Embodiments 1-4, wherein the wire-based packing material has a void fraction of greater than 0.95, greater than 0.9, greater than 0.85, or greater than 0.8.

Embodiment 6: The apparatus of any of Embodiments 1-5, wherein the wire-based packing material has a cavity size of less than 0.95 mm, less than 0.9 mm, less than 0.85 mm, less than 0.8 mm, or less than 0.75 mm.

Embodiment 7: The apparatus of any of Embodiments 1-6, wherein the wire-based packing material comprises polymeric wires, metal wires, natural fibers, or any combination thereof.

Embodiment 8: The apparatus of any of Embodiments 1-7, wherein the packing material comprises a wool material.

Embodiment 9: The apparatus of Embodiment 8, wherein the wool material comprises a material selected from the group consisting of steel, copper, lead, bronze, brass, aluminum, and combinations and alloys thereof.

Embodiment 10: The apparatus of Embodiment 8, wherein the wool material comprises a steel wool material or an alloy thereof (e.g., stainless steel wool and carbon steel wool).

Embodiment 11: The apparatus of Embodiment 8, wherein the wool material comprises a polymeric material.

Embodiment 12: The apparatus of any of Embodiments 8-11, wherein the wool material is selected from fine grade, medium grade, and coarse grade wools.

Embodiment 13: The apparatus of any of Embodiments 1-12, wherein the wire has an average filament thickness of about 20 μm to about 120 μm.

Embodiment 14: The apparatus of any of Embodiments 1-12, wherein the wire has an average filament thickness of about 40 μm to about 100 μm.

Embodiment 15: The apparatus of any of Embodiments 1-12, wherein the wire-based packing material comprises wires with a surface finish modification.

Embodiment 16: The apparatus of any of Embodiments 1-15, wherein the wire-based packing material comprises wires having one or more catalysts associated therewith (e.g., impregnated on/in, doped within, or surface treated to contain the one or more catalysts).

Embodiment 17: The apparatus of any of Embodiments 1-16, wherein the wire-based packing material is a single type of wire-based packing material and/or wherein the conduit comprises the wire-based packing material as the only packing material.

Embodiment 18: The apparatus of any of Embodiments 1-16, wherein the conduit comprises one or more additional packing materials in addition to the wire-based packing material.

Embodiment 19: The apparatus of any of claims 1-18, further comprising one or more components for the retention of the wire-based packing material.

Embodiment 20: The apparatus of Embodiment 19, wherein the one or more components are selected from the group consisting of a cage, one or more posts extending fully or partially between adjacent plates of the RPB, and combinations thereof.

Embodiment 21: The apparatus of Embodiment 20, wherein the cage is a mesh cylinder or mesh ring within which at least a portion of the wire-based packing material is retained.

Embodiment 22: The apparatus of any of Embodiments 1-21, wherein the RPB is equipped with a heat transfer mechanism (e.g., a heating and/or cooling mechanism).

Embodiment 23: The apparatus of any of Embodiments 1-22, adapted for removal of one or more acid gas components from a gas stream.

Embodiment 24: The apparatus of any of Embodiments 1-23, adapted for catalytic reaction.

Embodiment 25: The apparatus of any of Embodiments 1-24, adapted for use as a direct contact cooler (DCC) and/or for SO₂ removal from a gas stream.

Embodiment 26: The apparatus of any of Embodiments 1-25, adapted for water wash (aerosol/vapor removal) applications.

Embodiment 27: The apparatus of any of Embodiments 1-26, wherein the liquid is a non-aqueous solvent.

Embodiment 28: A catalytic reactor comprising the apparatus of any of Embodiments 1-27.

Embodiment 29: A system for the removal of one or more acid gas components from a gas stream comprising the apparatus of any of Embodiments 1-27 or the catalytic reactor of Embodiment 28.

Embodiment 30: The system of Embodiment 29, wherein the absorber comprises two or more additional RPBs (e.g., wherein the two or more additional RPBs are in parallel or in series).

Embodiment 31: The system of any of Embodiments 29 or 30, further comprising a regenerator in fluid communication with the absorber.

Embodiment 32: The system of claim 31, wherein the regenerator comprises a second RPB.

Embodiment 33: A method of effecting a catalytic reaction, comprising passing a gas stream into the gas inlet of the apparatus of any of Embodiments 1-27 or the catalytic reactor of Embodiment 28 or the system of any of Embodiments 29-32.

Embodiment 34: A method for treating a gas stream to remove one or more acid gas components therefrom, comprising passing the gas stream into the gas inlet of the apparatus of any of Embodiments 1-27 or the system of any of Embodiments 29-32.

Embodiment 35: A method of reducing capital and operating expenses associated with a system designed for capture of acid gas components from a gas stream, comprising employing the apparatus of any of Embodiments 1-27 within the system in place of a conventional packed column absorber or employing the system of any of Embodiments 29-32 in place of a conventional packed column absorber-based system.

Embodiment 36: The method of any of Embodiments 33-35, wherein the gas stream is a flue gas stream.

Embodiment 37: The method of Embodiment 36, wherein the gas stream is a flue gas stream from a natural gas combined cycle.

Embodiment 38: The method of any of Embodiments 33-35, wherein the gas stream is syngas from a gasifier that uses coal, biomass, or waste streams as fuel.

Embodiment 39: The method of any of Embodiments 33-37, wherein the gas stream is an exhaust stream from a boiler that uses biomass, natural gas, or a combination thereof as fuel.

These and other features, aspects, and advantages of the disclosure will be apparent from a reading of the following detailed description together with the accompanying drawings, which are briefly described below. The invention includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise. Other aspects and advantages of the present invention will become apparent from the following.

### BRIEF DESCRIPTION OF THE DRAWINGS

Having thus described the disclosure in the foregoing general terms, reference will now be made to the accompanying drawings, which are not necessarily drawn to scale, and wherein:

FIG. 1 is a depiction of a rotating packed bed (RPB) according to certain, non-limiting embodiments of the present disclosure;

FIG. 2 is a diagram of a reboiler-based system according to certain, non-limiting embodiments of the present disclosure, comprising an RPB for the capture of acidic components from a mixed gas stream with a liquid solvent and regeneration of the liquid solvent;

FIG. 3 is a schematic depiction of certain parameters relevant to calculating cavity size of packing materials according to certain, non-limiting embodiments of the disclosure;

FIG. 4 is a graph of results obtained with various grades of steel wool packing materials within an RPB according to certain embodiments of the present disclosure at a liquid flow rate of 4 L/G and gas flow rate of 500 SLPM;

FIG. 5 is a graph of non-limiting results obtained with various grades of steel wool packing materials within an RPB according to certain embodiments of the present disclosure at a flow rate of 2 L/G and gas flow rate of 500 SLPM;

FIG. 6 is a graph of non-limiting results obtained with various grades of steel wool packing materials within an RPB according to certain embodiments of the present disclosure at a flow rate of 2 L/G and variable gas flow rate;

FIG. 7 is a graph of non-limiting results obtained with various grades of steel wool packing materials within an RPB according to certain embodiments of the present disclosure at a flow rate of 4 L/G and variable gas flow rate;

FIG. 8 is a graph of non-limiting results obtained with various grades of steel wool packing materials with specified void fractions within an RPB according to certain embodiments of the present disclosure at a flow rate of 4 L/G and variable gas flow rate; and

FIG. 9 is a graph of non-limiting results obtained with various grades of steel wool packing materials with specified void fractions within an RPB according to certain embodiments of the present disclosure at a flow rate of 4 L/G and gas flow rate of 500 SLPM with variable Beta value.

### DETAILED DESCRIPTION

The present disclosure will now be described more fully hereinafter with reference to example implementations thereof. These example implementations are described so that this disclosure will be thorough and complete, and will fully convey the scope of the disclosure to those skilled in the art. Indeed, the disclosure may be embodied in many different forms and should not be construed as limited to the implementations set forth herein; rather, these implementations are provided so that this disclosure will satisfy applicable legal requirements. As used in the specification and the appended claims, the singular forms “a,” “an,” “the” and the like include plural referents unless the context clearly dictates otherwise.

As described hereinafter, the present disclosure relates to devices, systems, and methods for removal of gases, e.g., acid gases, from various gas streams (typically mixed gas streams). The terms “acid gas,” “acid gas components,” “acidic gas,” and “acidic gas components” are intended to encompass gas components that can result in the formation of an acid when mixed with water. Non-limiting examples of acid gases to which the disclosed devices, systems, and methods are applicable include carbon dioxide (CO₂), carbonyl sulfide (COS), carbon disulfide (CS₂), sulfur oxides (SOₓ, e.g., SO₂), or any combination thereof. The present disclosure further relates to devices, systems, and methods related to chemical conversions that can be conducted over a catalyst.

The disclosure provides rotating packed bed (RPB) devices, systems, and methods employing RPBs, e.g., suitable for use for acid gas removal from gas streams by gas-liquid mass transfer with liquid solvents, wherein the gas-liquid mass transfer is facilitated by a wire-based packing material (as will be described in further detail herein below). By employing a wire-based packing material as provided herein within an RPB, various improvements in gas-liquid absorption, resulting in significantly reduced operating costs can be obtained in the context of acid gas removal as compared with conventional absorbers and/or RPBs comprising conventional packing materials, as outlined herein below. The disclosure further provides RPB devices, systems, and methods employing such RPBs, e.g., suitable for facilitating certain chemical conversions, e.g., over one or more catalysts within an RPB.

Solvent-based systems and processes for removal of acid gases, as provided herein, generally involve passing a gas stream to be treated through a liquid solvent; acidic gas components (e.g., CO₂ and other acid gases mentioned above) interact with the liquid solvent and the acidic gas components are thereby separated from the remainder of the gas stream. This interaction between the liquid solvent and the acidic gas components can be classified as physical adsorption (utilizing pressure for the dissolution of acidic components in the liquid solvent) and/or chemical absorption (forming chemical bonds between the acidic components and the liquid solvent). The liquid solvent becomes rich in the acidic gas components, and the acidic gas components are typically removed to allow the liquid solvent to be recycled for further treatment of gas streams. For a liquid solvent that removes acidic components via physical absorption, removal of the gas components from a rich liquid solvent generally involves reducing the pressure of the liquid solvent. For a liquid solvent that removes acidic components via chemical absorption, removal of the gas components from a rich liquid solvent generally involves energy (e.g., heat) to reverse the reaction/break the chemical bonds formed between the liquid solvent and the acidic components.

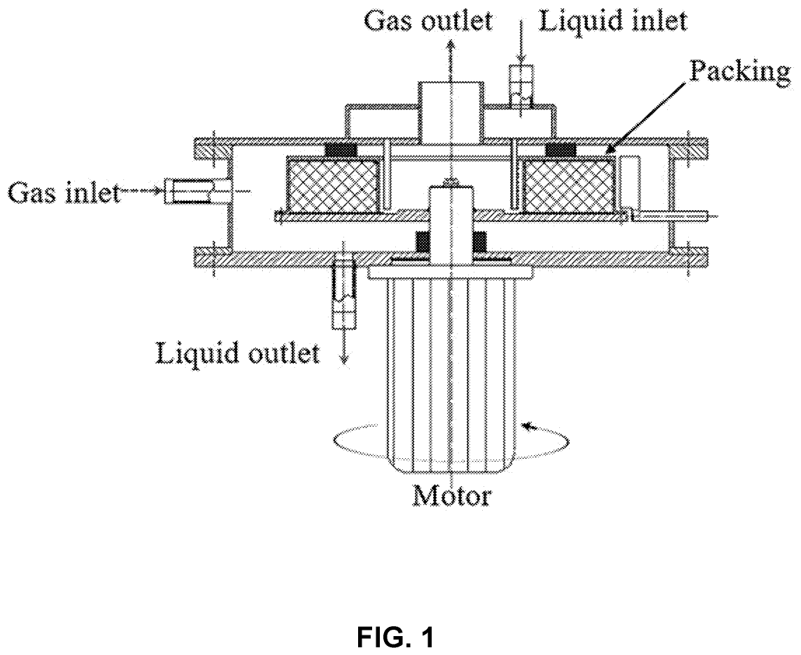

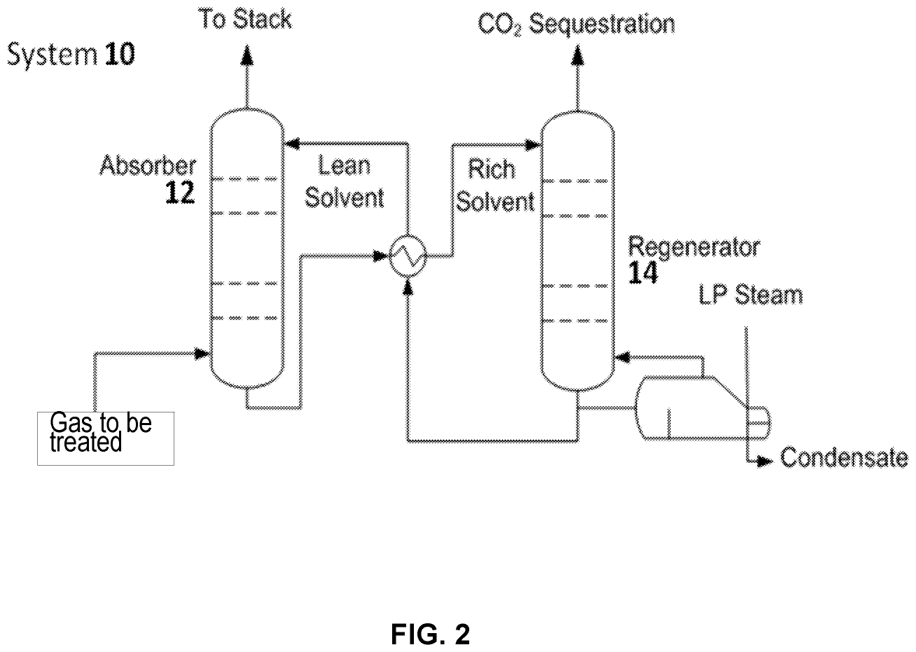

According to certain embodiments of the present disclosure, an absorber is provided which comprises a rotating packed bed (RPB), e.g., as schematically illustrated in FIG. 1. RPBs generally allow for a significant reduction in absorber size and cost as compared with conventional packed column-based systems. RPBs employ countercurrent gas-liquid scrubbing, but use centrifugal forces to increase the gas-liquid interfacial area. As shown, an RPB comprises a “packing” which, according to the present disclosure, comprises a wire-based packing material as described in further detail herein. The RPB can be used, in some embodiments, as an absorber within a gas treatment system, e.g., as schematically shown in FIG. 2 (absorber 12). It is noted that, although not depicted in FIG. 2, an RPB as described here may, in some embodiments, be used in an alternative or additional capacity within a given gas treatment system, e.g., in some embodiments, the system comprises a regenerator (e.g., depicted component 14) which comprises an RPB comprising the disclosed wire-based packing material.

RPBs and features thereof are generally known as described, for example, in U.S. Pat. No. 4,400,275 to Ramshaw et al.; U.S. Pat. No. 8,679,232 to Wolf et al.; and U.S. Pat. No. 9,987,589 to Kotagiri et al.; U.S. Patent Application Publication Nos. 2016/0243495 to Dutra et al. and 2020/0261846 to Mobley et al.; Wang et al., Ind. Eng. Chem. Res. 2008, 47, 8840-8846; Cortes Garcia et al., J. Chem. Tech. Biotech. 2017, 92(6), 1136-1156; Chamchan et al., J. Taiwan Inst. Chem. Eng. 2017, 73, 20-26; and Li et al., Chinese J. Chem. Eng. 2009, 17(3), which are incorporated herein by reference in their entireties. The exact type and configuration of the RPB employed according to the present disclosure is not particularly limited. For example, the direction of flow of the liquid and the gas to be treated with respect to one another can vary. In some embodiments, the RPB can be a cross-flow RPB; in some embodiments, the RPB can be a counter-flow RPB. Other configurations such as rotating zigzag beds (RZBs) are also known and can be employed as the RPB in the context of the present disclosure. The rotor design can vary widely, e.g., including different numbers of moving and/or stationary disks. Non-limiting examples of particular RPB designs that have been previously reported include, e.g., multi-stage spraying rotating packed bed, RPB with wave-form disk packing, helical rotating absorber, RPB with split packing, rotating zigzag bed (RZB), two-stage counter-current rotating packed bed, blade-packing rotating packed bed, counter-flow concentric ring rotating bed, and cross-flow concentric baffle rotating bed, as outlined in Cortes Garcia et al., J. Chem. Tech. Biotech 2017, 92(6), 1136-1156, which is incorporated herein by reference in its entirety. The RPB may comprise, in some embodiments, one or more intercoolers (e.g., applied to solvent between RPB stages) or one or more heating/cooling systems, which can be stationary and/or rotary and of different designs. In particular embodiments, a RPB with such a heating/cooling system as described in U.S. Pat. No. 11,691,105 to Mobley et al., which is incorporated herein by reference in its entirety, can be employed. In some embodiments, the RPB is adapted for use with non-aqueous liquid solvents, e.g., as described in U.S. Pat. No. 11,612,854 to Mobley et al., which is incorporated herein by reference in its entirety.

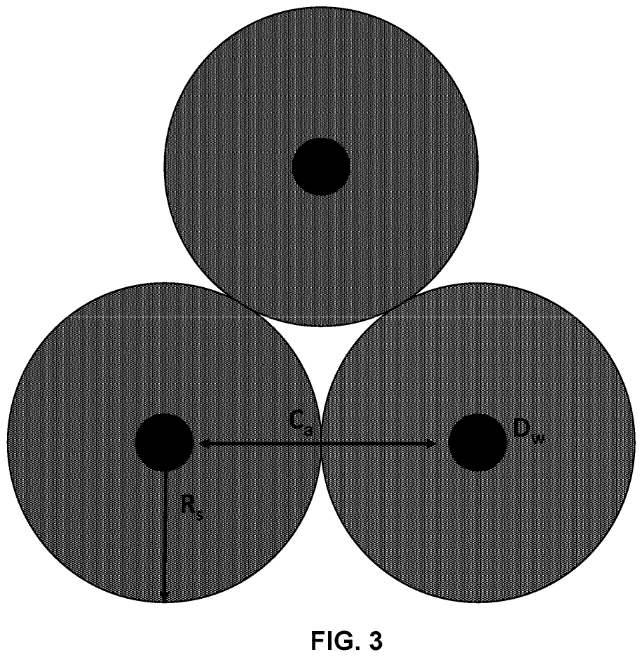

Most published data regarding packing materials for RPBs falls in a few main categories, namely, foams, woven materials (e.g., wire mesh), and knit materials (e.g., knit mesh, gauze), as well as structured packing (produced mechanically or by additive manufacturing). In some embodiments, the disclosed packing materials are wire-based packing materials, i.e., comprising one or a plurality of wires. Wire-based packing materials suitable for use within the disclosed RPBs can vary and include certain types of woven, knit, and nonwoven (e.g., wool) materials. Non-limiting schematic images of the types of structures encompassed by the terms “woven,” “knit,” and “nonwoven” materials are provided, e.g., in FIG. 3 of Misnon et al., Materials & Design (1980-2015) 59:359-368 (July 2014), which is incorporated herein by reference in its entirety.

Advantageously, in some embodiments, suitable wire-based packing materials within the RPBs according to the present disclosure exhibit relatively high porosities (and correspondingly relatively high void fractions), e.g., greater than about 80%, greater than about 85%, greater than about 90%, greater than about 95%, greater than about 96%, greater than about 97%, or greater than about 98%, e.g., up to about 99.9%, about 99.8%, or about 99.7%, about 99.6%, about 99.5%, about 99.4%, about 99.3%, or about 99.2%. Such porosity values are suitably measured using the mass of the total wire-based packing material divided by the density of the wire-based packing material to determine the wire-based packing material volume. The remainder is then considered to be the “void” content or “porosity” of the wire-based packing material and can be calculated by taking one minus the wire-based packing material volume divided by the total volume occupied by the wire-based packing material (where the porosity values provided above are the void fraction represented as a percentage).

In some embodiments, suitable wire-based packing materials are (alternatively or in addition) defined by the average cavity size of the void space within the wire-based packing material. In some embodiments, it is advantageous to minimize the average cavity size of the void space within the wire-based packing material. For example, in certain embodiments, various types of wire-based packing materials (including woven, knit, and nonwoven materials) are provided which exhibit average cavity sizes of less than about 5 mm, less than about 4 mm, less than about 3 mm, less than about 2 mm, less than about 1 mm, or less than about 0.95 mm, less than about 0.9 mm, less than about 0.85 mm, less than about 0.8 mm, or less than about 0.75 mm, with an average minimum average cavity size in some embodiments of about 0.2 mm, about 0.1 mm, or about 0.05 mm. A standard method for calculating cavity size is described below that can be applied to all wire-based packings including nonwoven, mesh, and knit packings.

| Variable | Definition | Equation | Units |
|---|---|---|---|
| m | Total wire mass | Measured | g |
| ρ | Wire material density | Measured | g/cm³ |
| V | Total wire volume | $V = \frac{m}{ρ}$ | cm³ |
| Dᵢ | Packing inner diameter | Measured | cm |
| Dₒ | Packing outer diameter | Measured | cm |
| H | Packing height | Measured | cm |
| D_{w} | Wire diameter (see FIG. 3) | Measured | cm |
| A_{w} | Wire cross sectional area | ${A}_{w} = {π ( \frac{{D}_{w}}{2} )}^{2}$ | cm² |
| L_{w} | Total wire length | ${L}_{w} = \frac{V}{{A}_{w}}$ | cm |
| N_{w} | Number of wire “height” units | ${N}_{w} = \frac{{L}_{w}}{H}$ | |
| Aₒ | Packing cross sectional area | Aₒ = N_{w}A_{w} | cm² |
| | occupied by wire | | |
| Aₚ | Total packing cross sectional area | ${A}_{p} = π ( {( \frac{{D}_{o}}{2} )}^{2} - {( \frac{{D}_{i}}{2} )}^{2} )$ | cm² |
| Aₒₚₑₙ | Open packing cross sectional area | ${A}_{o p e n} = \frac{{A}_{p} - {A}_{o}}{{N}_{w}}$ ${A}_{o p e n} = π ( {( {R}_{s} )}^{2} - {( \frac{{D}_{w}}{2} )}^{2} )$ | cm² |
| Rₛ | Spacing Radius (see FIG. 3) | ${R}_{s} = \sqrt{( \frac{{A}_{o p e n}}{π} ) + {( \frac{{D}_{w}}{2} )}^{2}}$ | cm |
| Cₐ | Average cavity size (see FIG. 3) | ${C}_{a} = 2 ( {R}_{s} - \frac{{D}_{w}}{2} )$ | cm |

First, the total wire volume (V) is calculated using the measured packing mass (m) and material density (ρ):

$$V = \frac{m}{ρ}$$

The wire cross-sectional area (A_{w}) is calculated using the wire diameter, which is then used with the total wire volume (V) to calculate the total length of wire (L_{w}) within the packing:

$${A}_{w} = π {( \frac{{D}_{w}}{2} )}^{2}$$

$${L}_{w} = \frac{V}{{A}_{w}}$$

To estimate the spacing between the wires, it is assumed that the wires are straight, in the same orientation, and span the height of the packing in the direction of the axis of rotation. This can be visualized as small lengths of wire in a vertical orientation distributed uniformly within the total packing volume. The number of height units is determined by dividing the total length of wire (L_{w}) by the packing height (H):

$${N}_{w} = \frac{{L}_{w}}{H}$$

Next, a cross-section of the packing containing these distributed wire heights can be examined. The area of the cross section occupied by wire (Aₒ) is obtained as follows:

Aₒ=N_{w}A_{w}

The total packing cross sectional area (Aₚ) is calculated using the packing dimensions:

$${A}_{p} = π ( {( \frac{{D}_{o}}{2} )}^{2} - {( \frac{{D}_{i}}{2} )}^{2} )$$

Therefore, the open packing cross sectional area per wire height unit (Aₒₚₑₙ) can be determined by subtracting the area occupied by wire from the total packing area and dividing by the number of units:

$${A}_{open} = \frac{{A}_{p} - {A}_{o}}{{N}_{w}}$$

The open packing cross sectional area per wire height can also be expressed as:

$${A}_{open} = π ( {( {R}_{s} )}^{2} - {( \frac{{D}_{w}}{2} )}^{2} )$$

Solving for the spacing radius (Rₛ):

$${R}_{s} = \sqrt{( \frac{{A}_{open}}{π} ) + {( \frac{{D}_{w}}{2} )}^{2}}$$

The average cavity size (Cₐ) can be expressed as twice the difference between the wire outer radius (D_{w}/2) and the spacing radius (Rₛ):

$${C}_{a} = 2 ( {R}_{s} - \frac{{D}_{w}}{2} )$$

Chen also investigated the use of different materials with random packed beads (an example of a particulate packing material as referenced herein). The cavity size was estimated using the following equation:

$${C}_{a} = \sqrt{6} ( \frac{D}{3} )$$

In some embodiments, it is advantageous to have the cavity size less than 5 mm, less than 4 mm, less than 3 mm, less than 2 mm, less than 1 mm, or less than 0.75 mm, e.g., with a minimum cavity size in some embodiments of about 0.2 mm, about 0.1 mm, or 0.05 mm.

The effective area of packing and/or mass transfer area of the wire-based packing material within the RPB is high. Effective area of packing, in some embodiments, can be measured using a 1M NaOH solution, e.g., based on a method as described in the following references: Munjal, S., “Fluid Flow and Mass Transfer in Rotating Packed Beds with Countercurrent Gas-Liquid Flow; Washington University, St. Louis MO 1986 and Ranjan S. et al., Ind. Eng. Chem. Res. 2011 (50), 986-997, which are both incorporated herein by reference in their entireties. The following measurements are required:
Concentration of NaOH in liquid, gmol/L
NaOH solution flow rate, L/s
Mole fraction of CO₂ in, vol %
Mole fraction of CO₂ out, vol %
Flow rate of air in gas, mol/s
Average temperature, ° C.
Average pressure, atm
RPB dimensions, m
   The interfacial area is calculated by using an iterative solver to find the aₑ value such that the mole fraction of CO₂ out matches the experimentally measured CO₂ mole fraction out. Rajan proposed the following equation to solve:

$${G}_{air} ( {y}_{{CO}_{2 i}} - {y}_{{CO}_{2 e}} ) = {a}_{e} P \frac{{y}_{{CO}_{2 i}}}{H} \sqrt{Dk} 2 π rh Δ r .$$

However, the equation above does not properly convert from mol/s of air to mol/s of CO₂ and was corrected in the equation below:

$${G}_{air} ( \frac{{y}_{{CO}_{2 i}}}{1 - {y}_{{CO}_{2 i}}} - \frac{{y}_{{CO}_{2 e}}}{1 - {y}_{{CO}_{2 e}}} ) = {a}_{e} P \frac{{y}_{{CO}_{2 i}}}{H} \sqrt{Dk} 2 π rh Δ r .$$

D is calculated with the following correlation in m²/s:

D=2.189*10⁻⁹−0.393*10⁻⁹*C_{NaOH}.

H is calculated with the following correlation in atm/(gmol/L):

H=H₀*10^{(h}^{₁}*^{I}^{₁}^{+h}^{₂}*^{I}^{₂}⁾

H₀=23.9+0.757*(T−18)

h_{G}=−0.019−0.000467*(T−25)

h₁=0.091+0.066+h_{G}

h₂=0.091+0.021+h_{G}

I₁=C_{NaOH}

I₂=3*C_{Na}_{₂}_{CO}_{₃}

k is calculated with the following correlation:

k₀*e^{(C}^{_{NaOH}}^{+3*C}^{_{Na2CO3}}⁾

k₀=4.2*10¹³*e(Eₐ/Rt)

Eₐ=13,250

R=1.987

t=T+273.15

To solve for aₑ, the difference in inner and outer radius of the RPB packing is broken into 1000 slices. The CO₂ mole fraction out of each slice according to Rajan would be calculated by rewriting the first equation:

$${y}_{{CO}_{2 e}} = {y}_{{CO}_{2 i}} - \frac{{a}_{e} P \frac{{y}_{{CO}_{2 i}}}{H} \sqrt{Dk} 2 π rh Δ r}{{G}_{air}} .$$

However, this equation must be replaced with the corrected equation:

$${y}_{{CO}_{2 e}} = \frac{1}{\frac{1}{( \frac{{y}_{{CO}_{2 i}}}{1 - {y}_{{CO}_{2 i}}} - \frac{{a}_{e} P \frac{{y}_{{CO}_{2 i}}}{H} \sqrt{Dk} 2 π rh Δ r}{{G}_{air}} )} + 1} .$$

The NaOH concentration for the next slice is calculated with a material balance:

$${Q}_{NaOH}^{′} * ( {C}_{NaOHi} - {C}_{NaOHe} ) = 2 {G}_{air} ( \frac{{y}_{{CO}_{2 i}}}{1 - {y}_{{CO}_{2 i}}} - \frac{{y}_{{CO}_{2 e}}}{1 - {y}_{{CO}_{2 e}}} ) .$$

The Na₂CO₃ concentration for the next slice is calculated with a material balance:

$${C}_{{Na}_{2} {CO}_{3} e} = {C}_{{Na}_{2} {CO}_{3} i} + \frac{( {C}_{NaOHe} - {C}_{NaOHi} )}{2} .$$

To optimize the numerical solver, the aₑ guess is updated after each iteration:

$${a}_{e ( i + 1 )} = {a}_{e ( i )} \frac{{y}_{{CO}_{2 i}} - {y}_{{CO}_{2 e , exp}}}{{y}_{{CO}_{2 i}} - {y}_{{CO}_{2 e , calc}}}$$

The solver stops iterating when the following condition is satisfied:

$$1 - abs ( \frac{{y}_{{CO}_{2 i}} - {y}_{{CO}_{2 e , exp}}}{{y}_{{CO}_{2 i}} - {y}_{{CO}_{2 e , calc}}} ) < 0.001 .$$

In certain embodiments, wire-based packing materials as provided herein are defined by both their porosity and their average cavity size, e.g., as having a porosity/void fraction and an average cavity size within the ranges disclosed above. For example, in one particular, non-limiting embodiment, an RPB is provided that comprises a wire-based packing material with a porosity of greater than 80% and an average cavity size of less than 1 mm.

In some embodiments, the effective mass transfer area provided by a wire-based packing material within the disclosed RPBs as described is significantly greater than that provided by conventional packing materials (e.g., including, but not limited to, conventional wire mesh packing material) within an otherwise comparable RPB operated under comparable conditions. This ability to provide greater effective mass transfer area can, in some embodiments, allow for system configurations with smaller RPBs (thereby increasing their applicability to large, commercial applications). In some embodiments, the effective area is about 600 m²/m³ or greater, about 700 m²/m³ or greater, or about 800 m²/m³ or greater at a liquid-to-gas (L/G) ratio of 4 kg/kg. In some embodiments, the effective area is about 800 m²/m³ or greater, about 900 m²/m³ or greater, or about 1000 m²/m³ or greater at a L/G ratio of 4. In some embodiments, the effective area is about 200 m²/m³ or greater, about 300 m²/m³ or greater, or about 400 m²/m³ or greater at a L/G ratio of 2 kg/kg. In some embodiments, the effective area is about 400 m²/m³ or greater, about 500 m²/m³ or greater, or about 550 m²/m³ or greater at a L/G ratio of 2. It is noted that the L/G ratio may be readily scalable beyond those values specifically referenced herein above and, accordingly, corresponding effective area values are also intended to be encompassed herein. Furthermore, the minimum disclosed effective area values can, in such embodiments, be modified by enhancing liquid distribution, particularly at lower L/G values.

As referenced herein above, some embodiments relate to RPBs with wire-based packing materials defined by certain physical characteristics, including, e.g., porosity/void fraction and average cavity size.

In some embodiments, RPBs are provided which comprise a packing material that is characterized as a wire-based material that is not a woven material, which may or may not also exhibit the physical properties outlined above. The RPBs provided in certain embodiments as provided herein comprise a wire-based packing material that is not a knit material. In some embodiments, the wire-based packing material is described as a material that cannot be classified as a foam, woven material, or knit material.

In some embodiments, the disclosed RPBs comprise a wire-based packing material characterized as a nonwoven material. In some embodiments, the packing material is a mechanically entangled nonwoven packing material, e.g., a wool packing material. A wool packing material can also be referred to in some embodiments as a wire sponge or wire wool. A wool packing material generally comprises a plurality of filaments (also referred to as wires or threads) intertwined/entwined or otherwise agglomerated with one another. In some embodiments, the plurality of filaments are arranged in a non-uniform (random) orientation with respect to one another and as such, are distinguished, e.g., from mesh materials and knitted structured packing materials, as well as foam-based packing materials.

The disclosed wire-based packing materials can comprise wires that are metal-based and/or wires that are not metal-based (e.g., comprising natural fibers and/or natural or synthetic polymers). In some embodiments, the wires comprise one or more materials selected from steel (e.g., stainless steel), copper, lead, bronze, brass, aluminum, and combinations and alloys thereof, including, e.g., carbon steel. In some embodiments the wires comprise one or more non-metal materials. In some such embodiments, suitable wires are selected from natural fibers and polymers (e.g., various thermoplastic materials including, but not limited to, nylons, poly(tetrafluoroethylene) (PTFE)), as well as elastomers and rubbers). Certain wire-based packing materials comprise all one type of wire and other wire-based packing materials comprise two or more different types of wire. In some embodiments, the wire-based packing material is selected with respect to the type of solvent to be employed within the RPB to ensure compatibility.

The filaments of a wire-based packing material as provided herein are typically very fine, although the exact diameter of the filaments is not particularly limited and the packing material can comprise filaments with substantially all the same diameter or filaments with two or more different diameters.

Certain wire-based wool packing materials are commercially available, e.g., steel wool, bronze wool, lead wool, bronze wool, brass wool, aluminum wool. In some embodiments, a polymeric material is adapted into a wool form, e.g., providing a polymeric wire-based wool packing material.

Wire-based wool packing materials as described in certain embodiments herein, in some embodiments, can be defined by their grade, which corresponds to the average filament thickness. In various embodiments, wool packing materials suitable for use as RPB packing materials according to the present disclosure can be super-fine grade/0000 #(with average filament thickness of about 25 μm), extra fine grade/000 #(with average filament thickness of about 35 μm), very fine grade/00 #(with average filament thickness of about 40 μm), fine grade/0 #(with average filament thickness of about 50 μm), medium grade/1 #(with average filament thickness of about 60 μm), medium coarse grade/2 #(with average filament thickness of about 75 μm), coarse grade/3 #(with average filament thickness of about 90 μm), extra coarse grade/4 #(with average filament thickness of about 100 μm), or any combination of two or more such materials.

In some embodiments, selection of a particular material for the wire-based packing material of the disclosed RPBs can be impacted by the specific application for which a given RPB is intended. For example, in some embodiments, a material can be selected so as not to react with the gas stream to be passed therethrough. In some embodiments, a material can be selected for use in a reactive system to serve as a catalyst; as one non-limiting example, an RPB comprising copper-containing wire-based packing material can be used to catalyze hydrogen production from methanol (improving reactivity and reducing the cost of the reactive system). Copper also serves as a catalyst for various other chemical reactions and can be employed as a wire-based packing material within an RPB for such purposes as well. In some embodiments, the wire-based packing material can be in the form of a wire-based packing material comprising doping or other surface modifications, e.g., to introduce selective reduction catalysts applicable to a range of reactive systems. In some embodiments, a wire-based packing material with one or more catalysts impregnated in the wire-based material is provided, e.g., for use in a catalytic reactor.

In some embodiments, the wire-based packing material comprises wire that has been surface treated. Surface treatment can include, for example, acid treatment. Acid treatment can, in some embodiments, roughen the surface of the wire-based material, which can increase the surface area associated with the treated wire-based material. The surface finish on a wire material can in some embodiments, affect fluid flow. In some embodiments, the wire-based packing material is washed or otherwise treated prior to incorporation within an RPB (or following incorporation within an RPB) to minimize the presence of loose material that may break free from the wire-based material in use.

In some embodiments, an RPB is provided which comprises a wire-based packing material as described herein as the only packing material within the RPB. As such, in some embodiments, the wire-based packing material consists or consists essentially of one or more types of the wire-based packing materials disclosed herein. As such, in some embodiments, the RPB comprises no foam packing material. In other embodiments, the disclosed wire-based packing material can be used in combination with one or more other types of packing materials. For example, in one non-limiting example, particulate packing material can be used in combination with the disclosed wire-based packing material, e.g., interspersed within the wire-based packing material in a random or non-random fashion or in a separate section, such that the packing material of the RPB comprises a first region comprising wire-based packing material and a second region comprising another type of packing material (e.g., particulate packing material). In another example, a foam or mesh packing material can be used in combination with the disclosed wire-based packing material, e.g., interspersed within the wire-based packing material in a random or non-random fashion or in a separate section, such that the packing material of the RPB comprises a first region comprising the disclosed wire-based packing material and a second region comprising another type of packing material (e.g., foam or mesh packing material).

For example, in some embodiments, the disclosed wire-based packing material is positioned at the interior of the packing material region of the RPB, extending circumferentially outward, and a second type of packing material is positioned at the exterior of the packing material region of the RPB; in other embodiments, the disclosed wire-based packing material is positioned at the exterior of the packing material region of the RPB, extending circumferentially inward, and a second type of packing material is positioned at the interior of the packing material region of the RPB.

In some embodiments, the disclosed wire-based packing material is contained within one or more structural components designed to secure and/or stabilize the wire-based packing material. Such structural components are not particularly limited and can, for example, include cylinders, rings, posts, cages, and the like and can be produced from various materials, e.g., metals and/or polymers. In some embodiments, such structural components can comprise a mesh material, e.g., a wire mesh. The structural components may strengthen the RPB in one or more of the radial, circumferential, and axial directions. For example, the structural components may reduce shifting of the packing material during manufacture and/or use. Where a mesh material is employed in this capacity, it is to be understood that it is not intended to function as a further packing material and can be included in an amount sufficient to secure the wire-based packing material as desired. In some embodiments, cylinders can be used in the form of concentric rings or segments, suitable for retaining the wire-based packing material and limiting shifting during manufacture or use of such material. In some embodiments, the one or more structural components comprise one or more posts extending fully or partially between adjacent discs within the RPB. In some embodiments, the additional component(s) can keep the disclosed wire-based packing material largely immobile within the conduit. Advantageously, balance of the overall RPB (including both the wire-based packing material and the support component(s) is considered to ensure the RPB is not unbalanced, which can prevent its efficient operation, particularly for stable high speed operation. One of skill in the art will be aware of methods to ensure sufficient balance, e.g., by reworking the arrangement, amount, and/or types of wire-based packing material and/or structural component(s) or by otherwise compensating for their inclusion.

The amount of wire-based packing material within a given RPB according to the disclosure is not particularly limited. In some embodiments, it may be advantageous to maximize the amount of wire-based packing material within the RPB so as to maximize the effective mass transfer area.

The temperature and pressure within the RPB during operation may, in some embodiments, be controlled. RPBs can be operated at a range of temperatures and pressures that are applicable to the disclosed apparatus, systems, and methods. For example, in one, non-limiting embodiment (e.g., specifically for CO₂ capture), the temperature of the RPB may be maintained at about 20° C. to about 70° C., e.g., about 30° C. to about 60° C., or about 40° C. to about 50° C., and the RPB can be held at a single temperature during use or can be varied. The disclosed RPB can, however, be operated at any temperature desired for a particular application. As such, in some embodiments, the RPB is equipped with a heating and/or cooling system, as referenced herein above, such that the operating temperature can be adjusted as desired. The RPB is typically operated near atmospheric pressure but can, in some embodiments, be operated at a pressure greater than atmospheric pressure or below atmospheric pressure. Furthermore, the rotational speed at which the RPB is operated can vary and may be modified to obtain suitable gas component removal from the gas stream. The liquid flow rate and the gas flow rate can be varied in some embodiments. Liquid to gas (L/G) mass ratios can be about 0.5 to about 10 kg/kg or about 0.5 to about 8 kg/kg. Specific examples of liquid to gas mass ratios include, but are not limited to, rates of about 0.83, about 1.67, about 2.5, about 3.33, about 0.49, about 0.98, about 1.46, and about 1.95, as well as all ranges therebetween. It is noted that certain such L/G ratios are relevant specifically to CO₂ capture and it is to be understood that for some applications, L/G ratios outside the disclosed ranges may be employed.

The present disclosure encompasses an RPB apparatus alone and also encompasses gas treatment systems comprising such an RPB apparatus. In addition to the RPB comprising a wire-based packing material as provided herein, the other components of the system are not particularly limited. The RPB can be inserted in place (or in addition to) a conventional absorber within any gas treatment system via appropriate modification of the system. Advantageously, the RPB can provide for a smaller overall footprint of the system as compared with a comparable system using a conventional absorber. The systems in which the disclosed RPBs can be employed can vary widely and other components can be included immediately upstream, immediately downstream, or elsewhere within the system.

When the disclosed RPB is incorporated within a gas treatment system, it is noted that, where more than one RPB is present in the system, one or more than one (including all) RPBs can comprise a wire-based packing material as described herein. In some embodiments, one or more other types of RPBs (e.g., comprising conventional packing materials) can be employed in a given system (in addition to the disclosed RPBs comprising a wire-based packing material). In certain, non-limiting embodiments, a gas treatment system as provided herein may optionally incorporate a filter or other apparatus designed to trap and/or remove any loose wire packing material that may, in some embodiments, be released from the disclosed RPBs during use.

One, non-limiting gas treatment system is schematically illustrated in FIG. 2. In FIG. 2, system 10 comprises the disclosed RPB as absorber 12 (configured with a gas inlet to receive a gas stream to be treated, a solvent inlet to receive lean solvent influent, and gas and liquid outlets to remove treated gas and rich solvent effluent, respectively from the absorber) and an optional regenerator/desorber 14. This figure is intended to be exemplary in nature and the system provided herein can be arranged in an alternative manner and can include any number of additional (unpictured) components. Although the system 10 is illustrated as comprising a single RPB (12), it is noted that this depiction is not intended to be limiting. In some embodiments, two (or more) RPBs can be contained within a gas treatment system, e.g., in series. In some embodiments, the solvent is advantageously cooled between absorption stages and the gas and liquid countercurrently progress through the series of two or more RPBs. In one example embodiment, a gas travels through RPB 1, then 2, and so on; and a liquid travels in the other direction (e.g., from 2 to 1 in an example comprising two RPBs), going through heat exchanges in between. Such a system could comprise two (or more) completely separate RPBs or can comprise RPBs connected on the same shaft in separated stages.

A gas treatment system may include an optional regeneration system 14 (as shown in FIG. 2) to release the captured acid gas via a separate acid gas stream and thus regenerate the solvent system. The regeneration system is configured to receive a feed of “rich” solvent from the RPB and to return regenerated solvent to the RPB once the acid gas has been separated from the “rich” solvent. The regeneration system may simply comprise a chamber with a heating unit to heat the solvent system at a temperature sufficient to release the gas, along with a release valve to allow the acid gas to be removed from the regeneration system. It may be, in some embodiment, a distillation column; in further embodiments, the regeneration system can comprise a further RPB (which may or may not comprise a wire-based packing material as described herein). In embodiments wherein the regeneration system comprises an RPB, the system is typically equipped with a heater applied to the solvent before it is introduced into the regeneration RPB or the system is set up with a reboiler configuration (e.g., where steam is produced in a reboiler and is the gas inlet to the regeneration RPB). The temperature of operation of an RPB employed for regeneration is generally considerably higher than the temperatures referenced herein above for the absorber RPB, as would be recognized by one of skill in the art.

The regenerator may be optionally connected to one or more components. For example, the regenerator is preferably configured with a means for routing solvent to a unit wherein water may be decanted, centrifuged, or otherwise removed from the system. The released acid gas can be separated/withdrawn from the system and output to storage or for other predetermined uses. The regenerated solvent system is again ready to absorb acid gas from a gas stream, and may be directed back into the RPB. It will be appreciated that any of the liquid and/or gas streams associated with the rotating packed bed apparatus or assemblies of multiple such apparatus may be heated or cooled in a heat exchanger with heating or cooling fluid from any suitable source.

In operation, various parameters of the disclosed RPB (as well as other components of the system, where present) can be adjusted to obtain suitable results. For example, the rotor speed of the RPB may, in some embodiments, be widely varied to affect performance. To normalize the rotational speed for different scales, the average dimensionless high gravity factor, or Beta term used in Jiao 2010 can be used as shown below:

$$β = \frac{{ω}^{2} r}{g}$$

$$\overline{β} = \frac{{\int }_{{r}_{1}}^{{r}_{2}} β 2 π r}{{\int }_{{r}_{1}}^{{r}_{2}} 2 π r} = \frac{2 {ω}^{2} ( {r}_{1}^{2} + {r}_{1} {r}_{2} + {r}_{2}^{2} )}{3 ( {r}_{1} + {r}_{2} ) g}$$

In some embodiments, for example, the RPB can be operated with a rotor speed corresponding to an average Beta of 0.3 or greater, 1 or greater, 10 or greater, 20 or greater, 50 or greater, 75 or greater, 100 or greater, 125 or greater, 150 or greater, or 175 or greater. The solvent used within the disclosed RPB can vary and can, in some embodiments, comprise one or more of the types of solvent systems described in U.S. Pat. No. 11,612,854, which is incorporated herein by reference in its entirety. Suitable solvent systems can comprise a physical absorbent, a chemical absorbent, or both a physical absorbent and a chemical absorbent. Certain, non-limiting solvent systems for use in the disclosed RPBs and systems include, e.g., a non-aqueous liquid solvent comprising one or more hydrophobic primary amines and/or one or more hydrophobic secondary amines and, optionally, one or more diluents (e.g., selected from optionally substituted alcohols, optionally substituted phenols, optionally substituted nitrogen heterocycles, optionally substituted aliphatic hydrocarbons, optionally substituted ketones, optionally substituted aliphatic ethers, optionally substituted cyclic ethers, optionally substituted oxygen heterocycles, optionally substituted esters, optionally substituted amides, and mixtures thereof). In some embodiments, the solvent system is an ionic liquid.

The gas stream treated according to the disclosed apparatus, systems, and methods is not particularly limited. Gas streams treated by the disclosed apparatus, systems and methods generally are exhaust gases that are desirably treated before further use and/or release into the atmosphere. The origin of the gas streams treated by means of the disclosed apparatus, system, and/or method is not particularly limited and the disclosed RPB and associated systems and methods can be employed to treat any gas stream that is desirably subjected to treatment to remove one or more components therefrom (e.g., treatment to “scrub” the gas stream of one or more undesirable components). It is to be understood that the devices, systems, and methods provided herein can be adapted accordingly for the removal of any one or more contaminants as applicable to the particular source of the gas stream, so long as the general principles outlined herein are employed (e.g., the gas stream is contacted with an RPB comprising a wire-based packing material as described herein for the removal of one or more components therefrom).

In some embodiments, the exhaust gas is a post-combustion gas stream (referred to herein also as a “flue gas” stream), e.g., originating from the combustion of fossil fuels such as coal, oil, or natural gas. Many such gas streams comprise acid gas components such as carbon dioxide (CO₂) and, due to the environmental impact and increasing regulations on emissions of such acid gases, such post-combustion gas streams are typically treated to decrease the acid gas content thereof. Flue gas sources can be, e.g., from electricity generating units or industrial sites including coal, natural gas, biogas, and biomass combustion (including biomass processing for electricity or fuel production), cement, iron, or steel production, and waste-to-energy plant operations. In one non-limiting example, the flue gas stream is a flue gas stream from a natural gas combined cycle (“NGCC”). In another non-limiting example, the flue gas stream is a flue gas from cement or coal plants. In a further non-limiting example, the gas stream is a gas stream from pulp production or a papermill. In another non-limiting example, the gas stream to be treated could be a hydrocarbon containing gas stream, including, e.g., a natural gas stream or a fossil-fuel derived synthetic gas or syngas containing hydrocarbons mixed with compounds that must be removed before further use such as CO₂, H₂S, and/or COS. In some embodiments, the gas stream is syngas from a gasifier that uses coal, biomass, or waste streams as fuel. In some embodiments, the gas stream is an exhaust stream from a boiler that uses biomass, natural gas, or a combination thereof as fuel.

The applications of the disclosed RPB comprising a wire-based packing material are not limited to acid gas capture; rather, the disclosed RPB can be used in any application for which RPBs are currently used or may be used. As certain non-limiting examples, in some embodiments, the disclosed RPB can be used for SO₂ capture, water deaeration, hypochlorous acid production, particulate removal, for gas conditioning to cool and control the dewpoint of a gas, including as the direct contact cooler for a flue gas from an NGCC or coal plant before entering an absorber, and/or as a water wash to remove secondary amines from a treated gas stream that has had an acid gas (e.g., CO₂) or SO₂ removed by an amine-based capture process. In some embodiments, the disclosed RPB can be used as a catalytic reactor. Non-limiting examples of applications for which the disclosed RPB can be used include, e.g., the intensification of quasi-homogeneous catalytic hydrogenation, as described in Wang et al., Ind. Eng. Chem. Res. 2020, 59, 3, 1383-1392 and methanolysis of oil for the production of fatty acid methyl esters (biodiesel), as described in Chen et al., J. Taiwan Inst. Chem. Eng. 42, 6, 2011, 937-944, which references are both incorporated herein by reference in their entireties.

In some embodiments, additional benefits can be introduced to a system by use of an RPB as described herein. For example, the disclosed RPB can be adapted for SO₂ acid gas capture, e.g., by inclusion of a base in wash water within the RPB as described in Chu et al., Ind. Eng. Chem. Res. 57(6), 2018, 2329-2335 and Bai et al., Env. Eng. Sci. 32, 9, 2015, 806-815 (which are both incorporated herein by reference in their entireties), which can be particularly relevant in treatment of exhaust gases from coal-fired power plants.

The devices, methods, and systems outlined herein provide various advantages over known devices, methods and systems. Advantageously, in some embodiments, RPBs comprising packing materials as described herein above provide one or more benefits with respect to a conventional packed tower absorber, one or more benefits with respect to an RPB with conventional packing material, or one or more benefits with respect to both a conventional packed tower and an RPB with conventional packing material. In some embodiments, an RPB comprising a packing material as described herein can provide similar performance as the conventional packed tower absorber or an RPB with conventional packing material with respect to one or more of absorption, regeneration, heat transfer, and/or mass transfer, but with a much smaller footprint and overall equipment size and cost.

One significant benefit associated with the disclosed RPBs in certain embodiments is lower weight. In some embodiments, the overall weight of the absorber unit is significantly decreased, while maintaining similar absorber performance. Lower weight can be beneficial, e.g., as the RPB may require less energy to rotate (e.g., as compared with an RPB comprising conventional packing material). In certain embodiments, decreasing the weight associated with a RPB can allow for effective rotation with reduced energy consumption, reduced shaft size limitations, and/or reduced issues with mounting the RPB, and/or concerns about vibration and other safety issues during use, even at high speeds. In some embodiments, the disclosed RPBs are useful in the concept of large applications, addressing concerns with the ability of RPBs to be made sufficiently large to be used in such systems by providing such high effective area for gas-liquid contact.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

### EXPERIMENTALS

Aspects of the present disclosure more fully illustrated by the following example, which is set forth to illustrate certain aspects of the present invention and is not to be construed as limiting thereof.

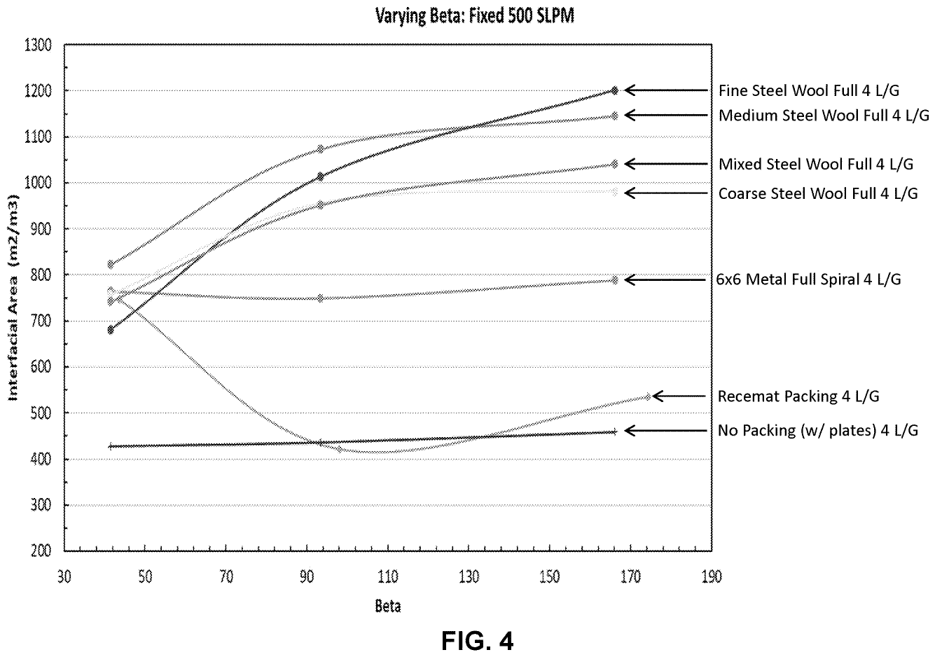

A RPB with various packings was prepared and tested at the bench-scale. The tested packings included: fine steel wool, medium steel wool, coarse steel wool, and mixed steel wool (i.e., with layers of packing radially where the coarse steel wool had the smallest radius and layers of medium and fine steel wool were added at medium and larger radii, respectively); for comparison, data is also shown for reference with: no packing in the RPB and only a fine spray of 1M NaOH through the RPB; a 6×6 wire mesh, and a metal foam produced by Recemat (NC0610) for reference. Effective area of packing was measured using a 1M NaOH solution; the reaction kinetics in the liquid phase are so fast that the mass transfer resistance in the liquid can be neglected and the tests provide a reasonable measure of the effective gas-liquid interfacial area. In the tests described below, the gas inlet had about 4 vol % CO₂ (used as a common concentration in a flue gas from an NGCC plant). Rotor speed was varied and the results are set forth in FIGS. 4-7.

FIG. 4 shows the results obtained within a rotating packed bed for a range of packing materials with an L/G of 4 kg/kg and a gas flow of 500 SLPM, with the RPB operated at various speeds (revolutions per minute, corresponding to different average Betas averaged over the packing geometry, as shown). The variation in rotor speed was shown to modulate the effective area generally for the wire wools tested. Notably, all steel wool packings tested exhibited higher or comparable effective area (corresponding to better or comparable performance) than any of the comparative materials at Betas greater than about 55. In general, higher Betas resulted in increased relative performance for the fine wire wool; although not intending to be limited by theory, it is believed that this result was observed potentially because higher centrifugal forces were required to drive the liquid outward with the smaller pore spaces. For this example, the highest effective area was achieved with the medium grade of wire wool, which increased performance with increasing Betas. For the medium grade of wire wool, the increase in performance plateaued somewhat at higher values, which could be advantageous in some embodiments because it can achieve high effective areas with moderate energy to drive the packing rotation. Increasing system flow rates also increases performance as the flow is increased closer to the flooding point, which was not reached in this testing.

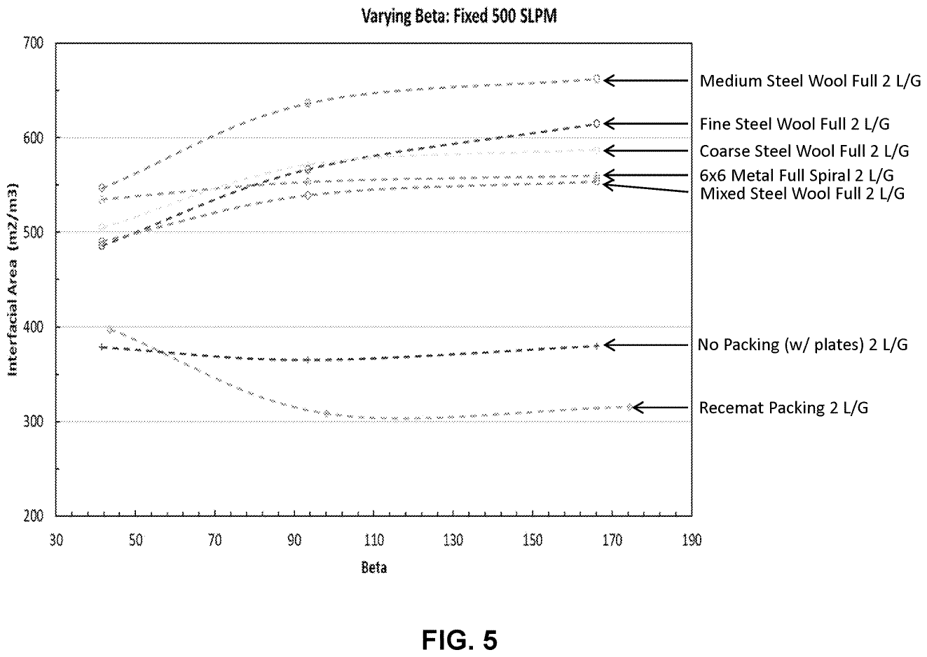

FIG. 5 shows the results obtained within a rotating packed bed for a range of packing materials with an L/G of 2 kg/kg and a gas flow of 500 SLPM, with the RPB operated at various speeds (revolutions per minute, corresponding to different average Betas averaged over the packing geometry, as shown). The variation in rotor speed was shown to modulate the effective area generally for the wire wools tested. As with the data shown in FIG. 4, the data shown at this reduced L/G demonstrated similar results, e.g., with the medium steel wool exhibiting the greatest interfacial area at all Betas tested (outperforming all other packings tested at all Betas tested). The interfacial area of all steel wools tested surpassed the Recemat NC0610 packing and no packing at all Betas tested. The interfacial area of the coarse steel wool surpassed the 6×6 metal full spiral packing at Betas above 70 and the interfacial area of the fine steel wool surpassed the 6×6 metal full spiral packing at Betas above about 80. The mixed steel wool exhibited similar (although slightly lower) interfacial area as the 6×6 metal full spiral at all Betas tested.

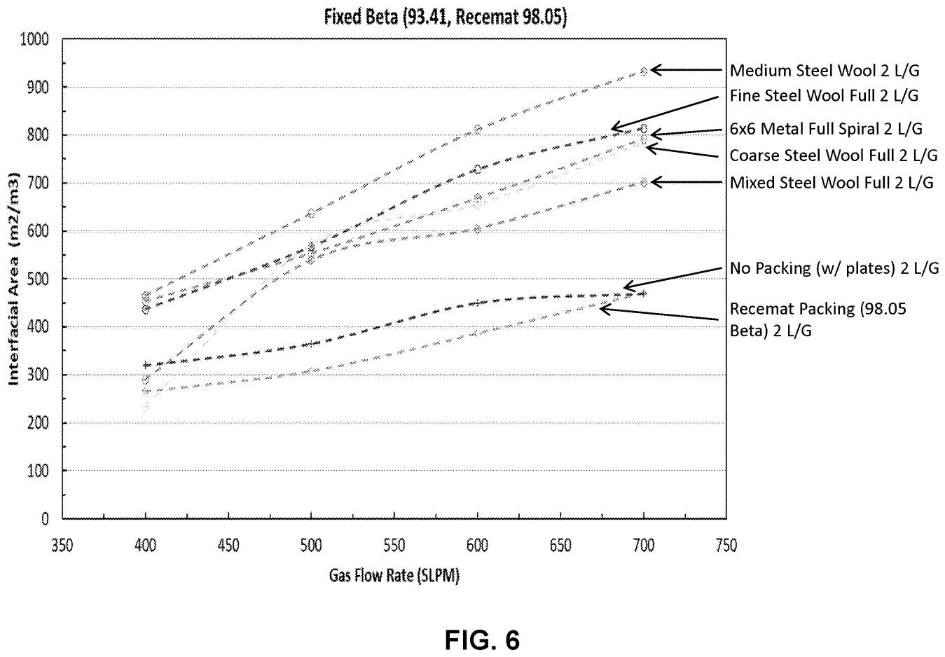

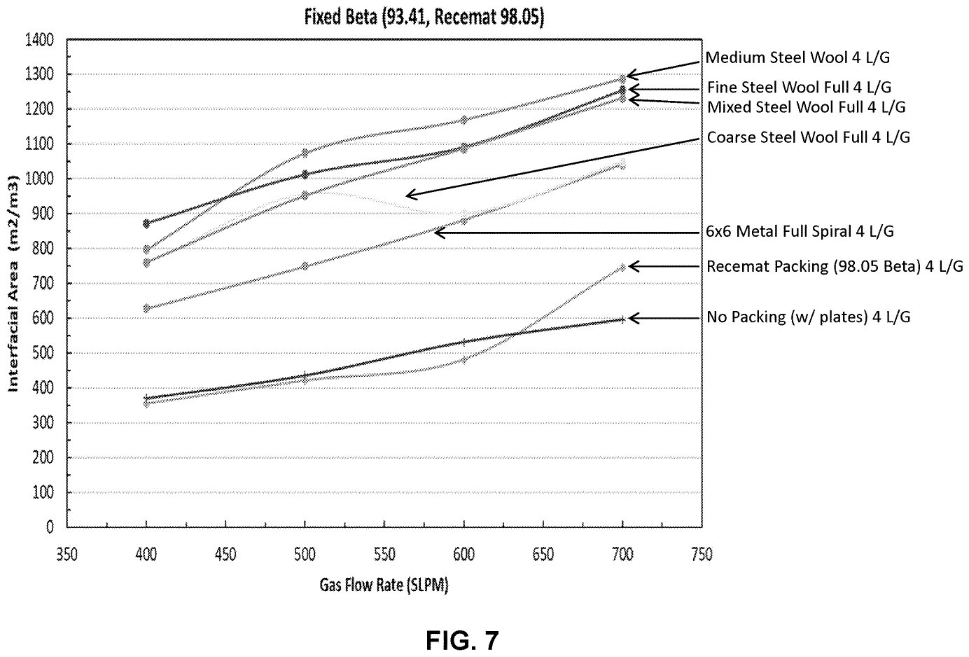

FIG. 6 shows the results obtained within a rotating packed bed for a range of packing materials with an L/G of 2 kg/kg and a variable gas flow rate, with the RPB operated at a fixed speed (revolutions per minute, corresponding to a Beta of 93.41/98.05 for the Recemat NC0610). As shown in the data presented, the medium steel wool exhibited the highest interfacial area of all materials tested at all gas flow rates. The RPB packed with fine steel wool exhibited a higher interfacial area than the RPB with Recemat NC0610 packing or no packing at all tested gas flow rates and a higher interfacial area than the RPB with 6×6 metal full spiral packing at all gas flow rates above about 475 SLPM. The RPB packed with coarse steel wool exhibited a higher interfacial area than the RPB with Recemat NC0610 packing at gas flow rates above about 410 SLPM and a higher interfacial area than the RPB with no packing at gas flow rates above 425 SLPM, with a comparable interfacial area to the RPB with 6×6 metal full spiral packing from about 480 SLPM to 700 SLPM. The RPB packed with mixed steel wool exhibited an interfacial area higher than that of the RPB with no packing or Recemat NC0610 packing at most tested gas flow rates (e.g., above 420 SLPM) but the comparative 6×6 metal spiral packing had a higher interfacial area than the RPB packed with mixed steel wool at all gas flow rates tested. As shown in FIG. 7, at a higher L/G value (of 4 kg/kg), RPBs comprising all tested wool packing materials were found to have a higher interfacial area (or equivalent, in the case of the coarse steel wool at higher gas flow rates) as compared with all comparative RPBs. Again, the medium steel wool outperformed the other steel wools tested at most flow rates.

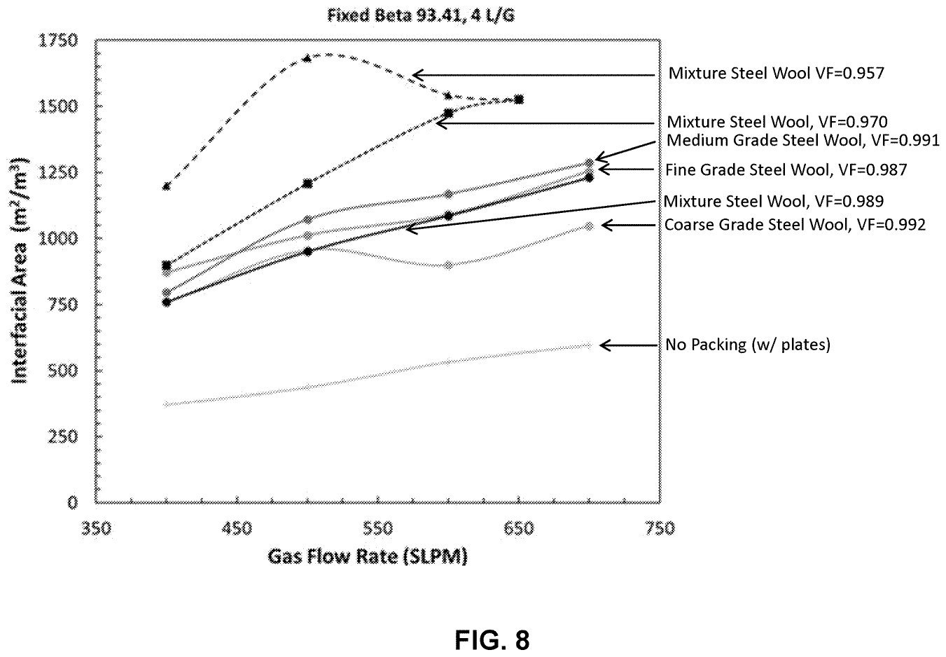

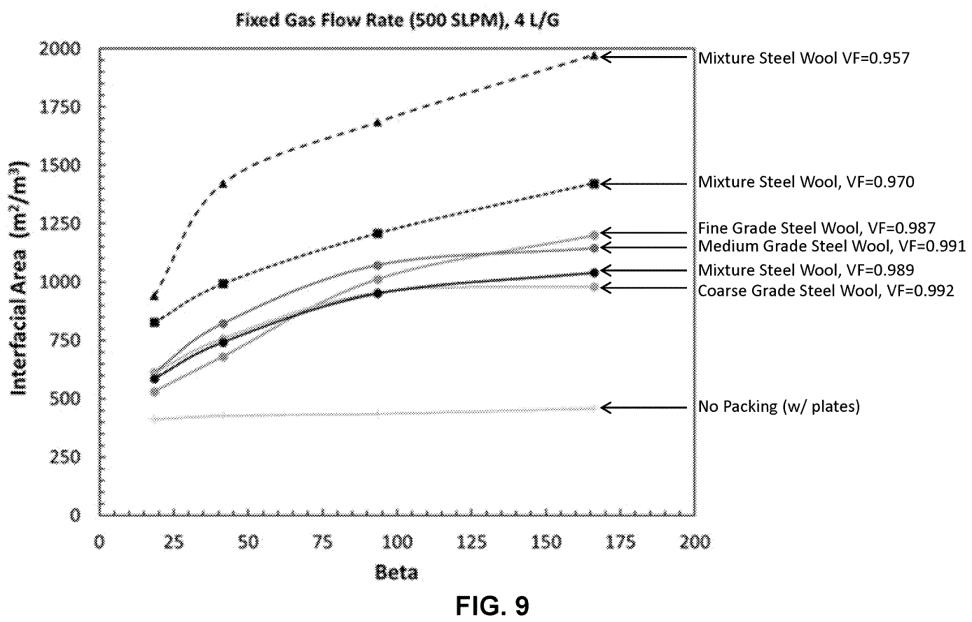

Two further studies are provided in FIGS. 8 and 9 with a range of packing materials, both with an L/G value of 4 L/G (with FIG. 8 demonstrating the effect of gas flow rate on interfacial area, and FIG. 9 demonstrating the effect of Beta values on interfacial area). Here, the mixture steel wool with void fraction 0.957 exhibited the highest interfacial area at all gas flow rates and all Beta values, with the mixture steel wool with void fraction 0.970 slightly lower. FIG. 8 indicated that there may be an optimal operating range for the packing as the mix of steel wool with void fraction 0.957 had a maximum at 475 SLPM. This may be driven by pressure drop or approach to flooding and the optimal combination of packing characteristics will depend on the application.

Generally, the testing demonstrated that, while the relevant L/G ratio would depend on the particular application, the packing and/or rotor size could be varied for different applications such that the effective area is maximized. The increase in the liquid flow rate as the gas flow rate was increased and the L/G ratio was held constant could have improved the liquid distribution and also increased mixing in the packing to improve the effective area in some embodiments. The performance could be improved at lower L/G ratios if the RPB was sized such that the gas and liquid flow rate were closer to the flooding point at the relevant conditions. As such, use of the disclosed RPBs with wool material packing can be useful across a wide range of applications in a wide range of systems with suitable selection of operating parameters. The mixed wool packing could also increase in effectiveness as the scale of the rotor was increased and the wool density was varied according to the centrifugal forces at different radii (i.e., progressing from course to medium to fine with increasing radius of the packing).

What is claimed is:

1. An apparatus, comprising a rotating packed bed (RPB) arranged on a rotatable shaft, the RPB comprising:
a gas inlet through which an influent gas can enter for gas-liquid contact;
a gas outlet through which an effluent gas can exit following the gas-liquid contact;
a liquid inlet through which a liquid can enter for the gas-liquid contact;
a liquid outlet through which the liquid can exit following the gas-liquid contact; and
a conduit between the liquid inlet and the liquid outlet, the conduit comprising a liquid solvent for the gas-liquid contact contained therein, and
a packing material within the conduit, wherein the packing material comprises a wire-based packing material, and wherein:
a) the wire-based packing material has a void fraction of greater than 0.8 and a cavity size of less than 1 mm; and/or
b) the wire-based packing material is in the form of a mechanically entangled, nonwoven material.

2. The apparatus of claim 1, wherein the wire-based packing material has a void fraction of greater than 0.8 and a cavity size of less than 1 mm and is a woven, knit, or nonwoven material.

3. The apparatus of claim 1, wherein the wire-based packing material has a void fraction of greater than 0.8 and a cavity size of less than 1 mm and is in the form of a mechanically entangled nonwoven material.

4. The apparatus of claim 1, wherein the wire-based packing material has a void fraction of greater than 0.9, greater than 0.91, greater than 0.92, greater than 0.93, greater than 0.94, or greater than 0.95.

5. The apparatus of claim 1, wherein the wire-based packing material has a cavity size of less than 0.95 mm, less than 0.9 mm, less than 0.85 mm, less than 0.8 mm, or less than 0.75 mm.

6. The apparatus of claim 1, wherein the wire-based packing material comprises polymeric wires, metal wires, natural fibers, or any combination thereof.

7. The apparatus of claim 1, wherein the wire-based packing material comprises a wool material selected from the group consisting of a polymeric material, steel, copper, lead, bronze, brass, aluminum, and combinations and alloys thereof.

8. The apparatus of claim 7, wherein the wool material comprises a steel wool material or an alloy thereof (e.g., stainless steel wool or carbon steel wool).

9. The apparatus of claim 1, wherein the wire-based packing material comprises wires with an average filament thickness of about 20 μm to about 120 μm (e.g., an average filament thickness of about 40 μm to about 100 μm).

10. The apparatus of claim 1, wherein the wire-based packing material comprises wires modified so as to comprise a surface finish modification and/or so as to comprise one or more catalysts associated therewith (e.g., impregnated on/in, doped within, or surface treated to contain the one or more catalysts).

11. The apparatus of claim 1, wherein the conduit comprises one or more additional packing materials in addition to the wire-based packing material.

12. The apparatus of claim 1, further comprising one or more components for the retention of the wire-based packing material, wherein the one or more components are selected from the group consisting of a cage, one or more posts extending fully or partially between adjacent plates of the RPB, and combinations thereof.

13. The apparatus of claim 12, wherein the cage is a mesh cylinder or mesh ring within which at least a portion of the wire-based packing material is retained.

14. The apparatus of any of claim 1, wherein the RPB is equipped with a heat transfer mechanism (e.g., a heating and/or cooling mechanism).

15. The apparatus of claim 1, adapted for a process selected from:
removal of one or more acid gas components from a gas stream;
catalytic reaction; use as a direct contact cooler (DCC) and/or removal of SO₂ from a gas stream; and/or
water wash (aerosol/vapor removal) applications.

16. The apparatus of claim 1, wherein the liquid is a non-aqueous solvent.

17. A catalytic reactor comprising the apparatus of claim 1.

18. A system for the removal of one or more acid gas components from a gas stream comprising the apparatus of claim 1, optionally wherein the absorber comprises two or more additional RPBs and wherein the two or more additional RPBs are in parallel or in series.

19. A method of effecting a catalytic reaction or treating a gas stream to remove one or more acid gas components therefrom, comprising passing the gas stream into the gas inlet of the apparatus of claim 1.

20. A method of reducing capital and operating expenses associated with a system designed for capture of acid gas components from a gas stream, comprising employing the apparatus of claim 1 within the system in place of a conventional packed column absorber.
